(19) United States
(12) Patent Application Publication
(10) Pub. No.: US 2026/0328644 A1
(43) Pub. Date: Oct. 22, 2026

(54) OPTICAL MEASUREMENT APPARATUS AND OPTICAL MEASUREMENT METHOD

(71) Applicant: NTT, Inc., Tokyo (JP)

(72) Inventors: Akira KAWAI, Musashino-shi (JP); Shimpei SHIMIZU, Musashino-shi (JP); Takayuki KOBAYASHI, Musashino-shi (JP); Yutaka MIYAMOTO, Musashino-shi (JP)

(73) Assignee: NTT, Inc., Tokyo (JP)

(21) Appl. No.: 19/110,351

(22) PCT Filed: Sep. 14, 2022
(86) PCT No.: PCT/JP2022/034397

§ 371 Date: Mar. 10, 2025

(51) Int. Cl. G01M 11/02; G01M 11/00

(52) U.S. Cl. CPC G01M 11/0207; G01M 11/331

(57) ABSTRACT

An optical measurement device includes an image-forming optical system, a phase synchronization unit, an imaging unit, and a measurement unit. The image-forming optical system generates first demultiplexed light and second demultiplexed light by demultiplexing object light from the end face of an optical fiber. The image-forming optical system projects the second demultiplexed light and reference light onto the imaging unit. The phase synchronization unit emits the reference light of a second frequency and second phase synchronized with a first frequency and first phase of the first demultiplexed light to the image-forming optical system. The imaging unit images the projected second demultiplexed light and the projected reference light. The measurement unit measures an optical complex amplitude distribution at the end face on the basis of the imaged second demultiplexed light and the imaged reference light.

### TECHNICAL FIELD

The present invention relates to an optical measurement device and an optical measurement method.

### BACKGROUND ART

In various fields such as optical communication (see Non Patent Document 1), optical imaging (for example, an endoscope or the like) (see Non Patent Document 2), and quantum computation (see Non Patent Document 3), a multimode fiber (spatial multiplexing fiber) may be used as a medium for transmitting an optical signal. Here, since a property of a multicore fiber having large crosstalk between cores is similar to a property of a multimode fiber, a multicore fiber may be used as a multimode fiber in a broad sense.

In the field of optical communication, a multimode fiber is used for, for example, mode-multiplexing transmission. In the mode-multiplexing transmission, each spatial mode of the multimode fiber is used as an independent channel, so that the capacity of transmission is substantially proportional to the number of modes of the multimode fiber.

Furthermore, use and utilization of the multimode fiber require prior evaluation of characteristics of the multimode fiber. Here, a transfer matrix of the multimode fiber may be evaluated. The transfer matrix of the multimode fiber includes information regarding inter-mode crosstalk of the multimode fiber, information regarding mode-dependent loss of the multimode fiber, and information regarding a phase relationship between modes of the multimode fiber.

In the field of optical communication, the operation amount of digital signal processing required at the time of reception increase as the crosstalk between modes is larger. Furthermore, the maximum capacity of communication decreases as the mode-dependent loss increases (see Non Patent Document 4). As described above, since the transfer matrix of the multimode fiber directly affect the quality of a communication system and the quality of a communication device using the multimode fiber, the evaluation of the transfer matrix of the multimode fiber is important.

As one of methods for measuring a transfer matrix, there is a method for measuring a transfer matrix by using digital holography. In the method for measuring a transfer matrix by using digital holography, object light (emitted light) emitted from an emission end of the multimode fiber and reference light (plane wave) to an imaging unit are projected on an imaging surface (image sensor) of the imaging unit. A measurement unit measures an interference waveform of the emitted light and reference light projected on the imaging surface. Thus, the measurement unit measures the intensity and phase distribution (optical complex amplitude distribution) of the object light at the emission end of the multimode fiber. Here, the optical complex amplitude distribution at the emission end of the multimode fiber is measured for each mode of the object light incident on the incidence end of the multimode fiber, and thus the transfer matrix can be evaluated.

However, in order to keep the phase relationship between the object light and the reference light constant, the optical path difference between the object light and the reference light needs to be less than the coherence length of the laser beam used for measurement. Thus, for example, it is difficult to apply the method for measuring a transfer matrix by using digital holography to evaluation of a transfer matrix of a multimode fiber having a length of several kilometers or more. Therefore, it is proposed to use a narrow linewidth laser that emits a laser beam having a long coherence length as a light source (see Non Patent Document 5).

### CITATION LIST

### Non Patent Documents

Non Patent Document 1: Mizuno, Takayuki, et al. “Dense space-division multiplexed transmission systems using multi-core and multi-mode fiber.” Journal of lightwave technology 34.2(2016): 582-592.

Non Patent Document 2: Ploschner, Martin, Tomas Tyc, and Tomas Cizmar. “Seeing through chaos in multimode fibres.” Nature Photonics 9.8(2015): 529-535.

Non Patent Document 3: Defienne, Hugo, et al. “Two-photon quantum walk in a multimode fiber.” Science advances 2.1(2016):e1501054.

Non Patent Document 4: Ho, Keang-Po, and Joseph M. Kahn. “Linear propagation effects in mode-division multiplexing systems.” Journal of lightwave technology 32.4(2014 ): 614-628.

Non Patent Document 5: Mazur, Mikael, et al. “Characterization of long multi-mode fiber links using digital holography.” Optical Fiber Communication Conference. Optical Society of America, 2019.

### SUMMARY OF INVENTION

### Technical Problem

However, the narrow linewidth laser is expensive. Furthermore, in a case where a distance from the incidence end to the emission end of the multimode fiber is long (for example, from several hundred meters to several kilometers or more), a fiber for transmitting the reference light is separately required. As described above, there is a case where the optical complex amplitude distribution at the emission end of the multimode fiber having a predetermined length or more cannot be measured at low cost.

In view of the above-described circumstances, an object of the present invention is to provide an optical measurement device and an optical measurement method, in which an optical complex amplitude distribution at an emission end of a multimode fiber having a predetermined length or more is capable of being measured at low cost.

### Solution to Problem

According to an aspect of the present invention, there is provided an optical measurement device including: an image-forming optical system; a phase synchronization unit; an imaging unit; and a measurement unit, in which the image-forming optical system generates first demultiplexed light and second demultiplexed light by demultiplexing object light from an end face of an optical fiber, and projects the second demultiplexed light and reference light onto the imaging unit, the phase synchronization unit emits, to the image-forming optical system, the reference light of a second frequency and a second phase which are synchronized with a first frequency and a first phase of the first demultiplexed light, the imaging unit images the projected second demultiplexed light and the projected reference light, and the measurement unit measures an optical complex amplitude distribution at the end face on the basis of the imaged second demultiplexed light and the imaged reference light.

According to another aspect of the present invention, there is an optical measurement method executed by an optical measurement device including an image-forming optical system, a phase synchronization unit, an imaging unit, and a measurement unit, the optical measurement method including: by the image-forming optical system, generating first demultiplexed light and second demultiplexed light by demultiplexing object light from an end face of an optical fiber, and projecting the second demultiplexed light and reference light onto the imaging unit, by the phase synchronization unit, emitting, to the image-forming optical system, the reference light of a second frequency and a second phase which are synchronized with a first frequency and a first phase of the first demultiplexed light, by the imaging unit, imaging the projected second demultiplexed light and the projected reference light, and by the measurement unit, measuring an optical complex amplitude distribution at the end face on the basis of the imaged second demultiplexed light and the imaged reference light.

### Advantageous Effects of Invention

According to the present invention, it is possible to measure the optical complex amplitude distribution at the emission end of the multimode fiber having a predetermined length or more at low cost.

### BRIEF DESCRIPTION OF DRAWINGS

FIG. 1 A diagram illustrating a configuration example of an optical measurement device according to a first embodiment.

FIG. 2 A diagram illustrating a hardware configuration example of a measurement unit according to the first embodiment.

FIG. 3 A diagram illustrating an example of optical phase synchronization according to the first embodiment.

FIG. 4 A flowchart illustrating an operation example of an optical measurement device according to the first embodiment.

FIG. 5 A diagram illustrating a configuration example of an optical measurement device according to a second embodiment.

FIG. 6 A diagram illustrating a configuration example of an optical measurement device according to a third embodiment.

FIG. 7 A diagram illustrating a configuration example of an optical measurement device according to a fourth embodiment.

FIG. 8 A diagram illustrating a configuration example of an optical measurement device according to a fifth embodiment.

### DESCRIPTION OF EMBODIMENTS Embodiments of the present invention will be described in detail with reference to the drawings.

### First Embodiment

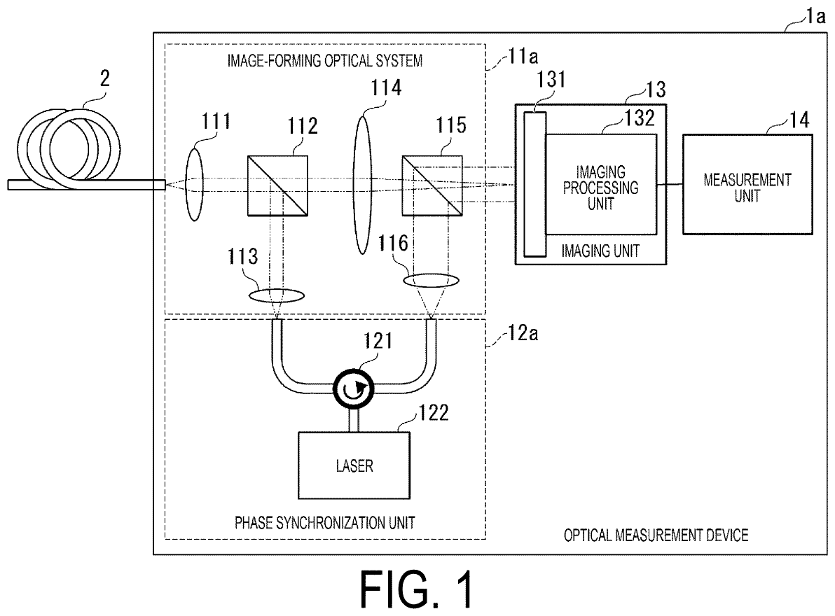

FIG. 1 is a diagram illustrating a configuration example of an optical measurement device 1a (measurement device) according to a first embodiment. The optical measurement device 1a includes an image-forming optical system 11a, a phase synchronization unit 12a, an imaging unit 13, and a measurement unit 14.

The image-forming optical system 11a includes a lens 111 (objective lens), a beam splitter 112, a lens 113, a lens 114 (image-forming lens), a beam combiner 115, and a lens 116. The position of the beam splitter 112 is, for example, between the lens 113 and the lens 114. The position of the beam combiner 115 is, for example, between the lens 114 (image-forming lens) and the imaging unit 13.

In a case where the phase synchronization unit 12a includes a fiber optical system, the image-forming optical system 11a may include a condenser lens for causing light to enter an optical fiber and a collimator lens for changing light emitted from the optical fiber into a plane wave. The image-forming optical system 11a may further include not only an optical system including a set of lens pairs (for example, a set of the lens 111 and the lens 114) but also a plurality of lenses of which aberrations and magnifications are considered.

The phase synchronization unit 12a includes an optical circulator 121 and a laser 122. The phase synchronization unit 12a may include at least one of a fiber optical system or a free space optical system. The phase synchronization unit 12a may include a mechanism (for example, a polarization stabilizer) for stabilizing polarization of light. The imaging unit 13 includes an imaging surface 131 and an imaging processing unit 132.

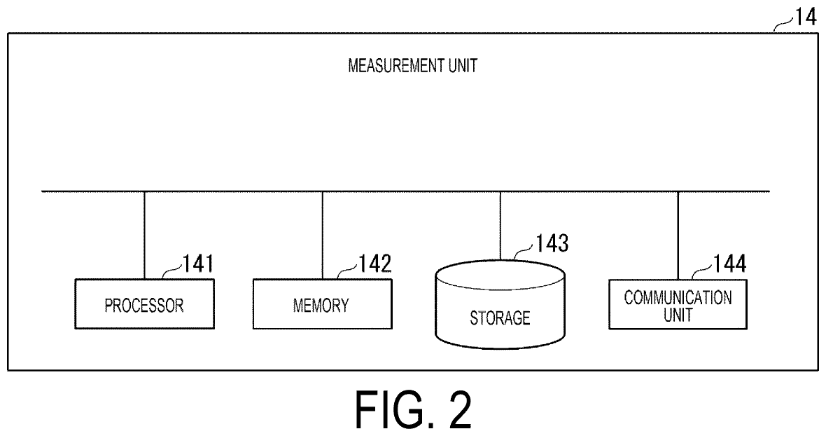

FIG. 2 is a diagram illustrating a hardware configuration example of the measurement unit 14 according to the first embodiment. The measurement unit 14 is implemented as software by a processor 141 such as a central processing unit (CPU) executing a program stored in a storage 143 including a nonvolatile recording medium (non-transitory recording medium) and a memory 142. The program may be recorded in a computer-readable recording medium. The computer-readable recording medium is, for example, a portable medium such as a flexible disk, a magneto-optical disc, a read only memory (ROM), or a compact disc read only memory (CD-ROM), or a non-transitory recording medium such as a storage such as a hard disk built in a computer system. A communication unit 144 executes communication processing.

The measurement unit 14 may be implemented by using hardware including an electronic circuit (or circuitry) using, for example, a large scale integrated (LSI) circuit, an application specific integrated circuit (ASIC), a programmable logic device (PLD), or a field programmable gate array (FPGA).

Returning to FIG. 1, each functional unit of the optical measurement device 1a will be described. Object light enters an incidence end of a multimode fiber 2 (first end face of the optical fiber). The multimode fiber 2 emits the object light (emitted light) transmitted through the multimode fiber 2 (transmission path) from an emission end of the multimode fiber 2 (second end face of the optical fiber). Object light (emitted light) emitted from the multimode fiber 2 is incident on the image-forming optical system 11a.

The image-forming optical system 11a demultiplexes the object light (incident light) incident from the multimode fiber 2, and the image-forming optical system 11a outputs one of the demultiplexed incident light beams (first demultiplexed light) to the phase synchronization unit 12a. The image-forming optical system 11a outputs (projects) the other one of the demultiplexed incident light beams (second demultiplexed light) and the reference light incident on the image-forming optical system 11a from the phase synchronization unit 12a to the imaging unit 13.

The phase synchronization unit 12a synchronizes the frequency and phase of the laser beam of the laser 122 with the frequency and phase of one incident light beam demultiplexed by the image-forming optical system 11a, for example, by using injection synchronization. The injection synchronization is a phenomenon in which, in a case where light of another continuous wave is incident on an output end of a laser, the frequency and phase of the laser beam output from the laser are synchronized with those of incident light of the continuous wave.

For example, the phase synchronization unit 12a uses light different from the object light transmitted through the multimode fiber 2 to be measured as reference light by using injection synchronization. The incident light to be the object light and the incident light to be the reference light may be different light beams (off-axis configuration). Furthermore, the incident light to be the object light and the incident light to be the reference light may be parallel with each other (in-line configuration).

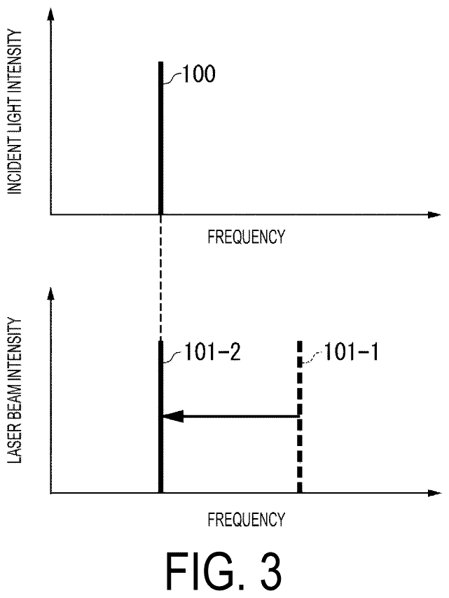

FIG. 3 is a diagram illustrating an example of optical phase synchronization according to the first embodiment. An intensity signal 100 represents the intensity of the object light incident on the phase synchronization unit 12a from the image-forming optical system 11a at a predetermined frequency. That is, the intensity signal 100 represents the intensity of the object light incident on the optical circulator 121. An intensity signal 101 represents the intensity of the laser beam (reference light) incident on the image-forming optical system 11a from the phase synchronization unit 12a at a predetermined frequency. That is, the intensity signal 101 represents the intensity of the laser beam (reference light) incident from the optical circulator 121.

For example, the frequency and phase of the intensity signal 101 are equal to the frequency and phase of the intensity signal 100 due to injection synchronization using the object light incident on the phase synchronization unit 12a from the image-forming optical system 11a. Since the light intensity (laser light intensity) of the intensity signal 101 does not change much before and after the injection synchronization, it is possible to generate the intensity signal 101 (reference light) having a constant light intensity regardless of the light intensity (incident light intensity) of the intensity signal 100.

Returning to FIG. 1, each functional unit of the optical measurement device 1a will be continuously described. The imaging unit 13 images the interference waveform of the object light and the reference light which are incident on the imaging unit 13 from the image-forming optical system 11a. The measurement unit 14 derives an optical complex amplitude distribution at the emission end of the multimode fiber 2 by performing signal processing (digital holography measurement).

Next, the details of each functional unit of the optical measurement device 1a will be described.

Object light (emitted light) emitted from the multimode fiber 2 is incident on the lens 111 (objective lens) as object light (incident light) incident on the lens 111. The beam splitter 112 demultiplexes the incident light on the beam splitter 112 into the lens 113 and the lens 114.

The lens 113 causes the incident light demultiplexed by the beam splitter 112 to be incident on the optical circulator 121.

The optical circulator 121 emits the incident light from the lens 113 to the lens 116. The optical circulator 121 emits the emitted light from the laser 122 to the lens 116. That is, the optical circulator 121 injects the object light incident from the image-forming optical system 11a into the laser beam, and thus the laser beam synchronized with the frequency and phase of the incident object light is emitted to the image-forming optical system 11a.

The laser 122 may be a narrow linewidth laser or a distributed feedback laser. The laser 122 emits laser beam having a predetermined frequency and phase to the beam splitter 112. The lens 114 (image-forming lens) projects an optical image (object image) adjusted to an appropriate magnification on the imaging surface 131 by using the incident light demultiplexed to the lens 114 by the beam splitter 112.

The beam combiner 115 multiplexes the light emitted from the lens 114 and the light emitted from the lens 116. The lens 116 emits the laser beam (reference light) emitted from the optical circulator 121 to the beam combiner 115.

The imaging surface 131 (image sensor) includes, for example, silicon (Si) or indium gallium arsenide (InGaAs). The imaging surface 131 images the light multiplexed by the beam combiner 115. That is, the imaging surface 131 images an interference waveform of the object light and reference light projected on the imaging surface 131. The imaging processing unit 132 generates an image signal corresponding to the interference waveform of the object light and the reference light at a predetermined cycle. The imaging processing unit 132 outputs the generated image signal to the measurement unit 14.

The measurement unit 14 derives an optical complex amplitude distribution at the emission end of the multimode fiber 2 by executing signal processing on the image signal. For example, in a case where the off-axis configuration is used by the phase synchronization unit 12a, the measurement unit 14 performs two-dimensional Fourier transform on the image signal according to the interference waveform of the object light and the reference light. The measurement unit 14 extracts an appropriate band of a spatial frequency from the result of the two-dimensional Fourier transform. The measurement unit 14 shifts the extracted band to the vicinity of the frequency “zero”. The measurement unit 14 derives an optical complex amplitude distribution at the emission end of the multimode fiber 2 by performing two-dimensional inverse Fourier transform on the shifted band.

As described above, the optical measurement device la synchronizes the frequency and phase of the laser beam of the laser 122 installed on the output side of the phase synchronization unit 12a with the frequency and phase of the emitted light from the multimode fiber 2 by using, for example, injection synchronization. Thus, it is possible to measure the digital holography without being limited by the coherence length of the light source.

Next, an operation example of the optical measurement device 1a will be described.

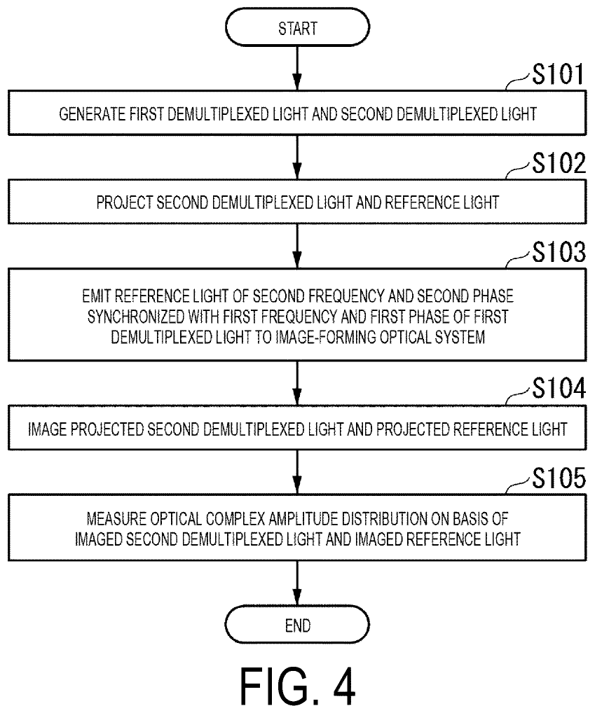

FIG. 4 is a flowchart illustrating the operation example of the optical measurement device 1a according to the first embodiment. The image-forming optical system 11a generates the first demultiplexed light and the second demultiplexed light by demultiplexing the object light from the end face of the multimode fiber 2 (step S101). The image-forming optical system 11a projects the second demultiplexed light and the reference light onto the imaging unit 13 (step S102).

The phase synchronization unit 12a emits reference light of a second frequency and second phase synchronized with a first frequency and first phase of the first demultiplexed light to the image-forming optical system 11a (step S103). The imaging unit 13 images the projected second demultiplexed light and the projected reference light (step S104).

The measurement unit 14 measures the optical complex amplitude distribution at the end face of the multimode fiber 2 on the basis of the imaged second demultiplexed light and the imaged reference light (step S105).

As described above, the image-forming optical system 11a generates the first demultiplexed light and the second demultiplexed light by demultiplexing the object light from the end face of the optical fiber. The phase synchronization unit 12a uses the injection synchronization to synchronize the second frequency and second phase of the reference light with the first frequency and first phase of the first demultiplexed light. The phase synchronization unit 12a emits the reference light of the second frequency and second phase synchronized with the first frequency and first phase of the first demultiplexed light to the image-forming optical system 11a. The image-forming optical system 11a projects the second demultiplexed light having the first frequency and the first phase and the reference light synchronized with the first frequency and first phase of the first demultiplexed light onto the imaging unit 13. The imaging unit 13 images the projected second demultiplexed light and the projected reference light. The measurement unit 14 measures the optical complex amplitude distribution at the end face on the basis of the imaged second demultiplexed light and the imaged reference light.

Thus, it is possible to measure the optical complex amplitude distribution at the emission end of the multimode fiber having a predetermined length or more at low cost. For example, it is possible to measure the optical complex amplitude distribution (the intensity and the phase of the object light) at the emission end of a long-distance optical fiber by using an optical phase synchronization technology without requiring the optical fiber that transmits the reference light and a narrow linewidth light source. That is, it is possible to measure the optical complex amplitude distribution at the emission end of the long-distance optical fiber regardless of the coherence length of the incident light to the long-distance optical fiber.

### Second Embodiment

The second embodiment is different from the first embodiment mainly in that the phase synchronization unit includes an amplifier (optical amplifier). In the second embodiment, the difference from the first embodiment will be mainly described.

The light intensity of the object light transmitted through the long-distance optical fiber attenuates according to the transmission distance of the object light. In a case where the light intensity attenuates, injection synchronization may not be performed. In the second embodiment, the phase synchronization unit includes the amplifier (optical amplifier).

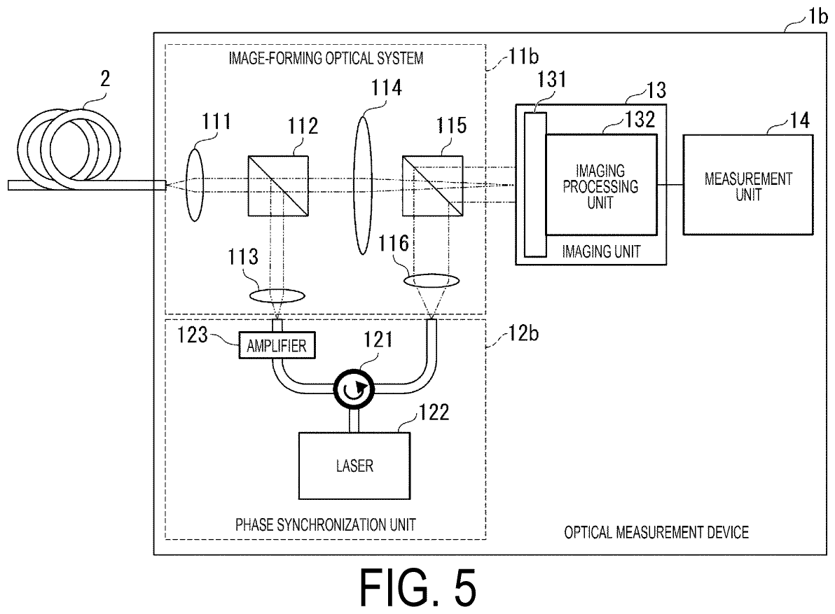

FIG. 5 is a diagram illustrating a configuration example of an optical measurement device 1b according to the second embodiment. The optical measurement device 1b includes an image-forming optical system 11b, a phase synchronization unit 12b, an imaging unit 13, and a measurement unit 14.

The image-forming optical system 11b includes a lens 111, a beam splitter 112, a lens 113, a lens 114, a beam combiner 115, and a lens 116. The phase synchronization unit 12b includes an optical circulator 121, a laser 122, and an amplifier 123. The imaging unit 13 includes an imaging surface 131 and an imaging processing unit 132.

The amplifier 123 (optical amplifier) is, for example, an erbium-doped fiber amplifier, a semiconductor amplifier, or a Raman amplifier. The amplifier 123 amplifies the light intensity of the incident light demultiplexed from the lens 113. The amplifier 123 may include an optical band-pass filter on the optical circulator 121 side of the amplifier 123. The optical band-pass filter removes amplified spontaneous emission (ASE) generated by the amplifier 123 from incident light in the amplifier 123. The optical band-pass filter can reduce the influence of the amplified spontaneous emission generated by the amplifier 123.

As described above, the phase synchronization unit 12b includes the amplifier 123. The amplifier 123 amplifies the light intensity of the incident light demultiplexed from the lens 113. Thus, even in a case where the light intensity of the object light attenuates according to the transmission distance of the object light, it is possible to measure the optical complex amplitude distribution at the emission end of the multimode fiber having a predetermined length or more at low cost. Furthermore, since the phase synchronization unit 12b includes the amplifier 123 for enhancing the incident light from the image-forming optical system 11b, the amplifier 123 recovers the light intensity even in a case where the light intensity of the incident light is weak. Therefore, the injection synchronization can be performed.

### Third Embodiment

A third embodiment is different from the first embodiment mainly in that the image-forming optical system includes a polarization multiplexing unit. In the third embodiment, the difference from the first embodiment will be mainly described.

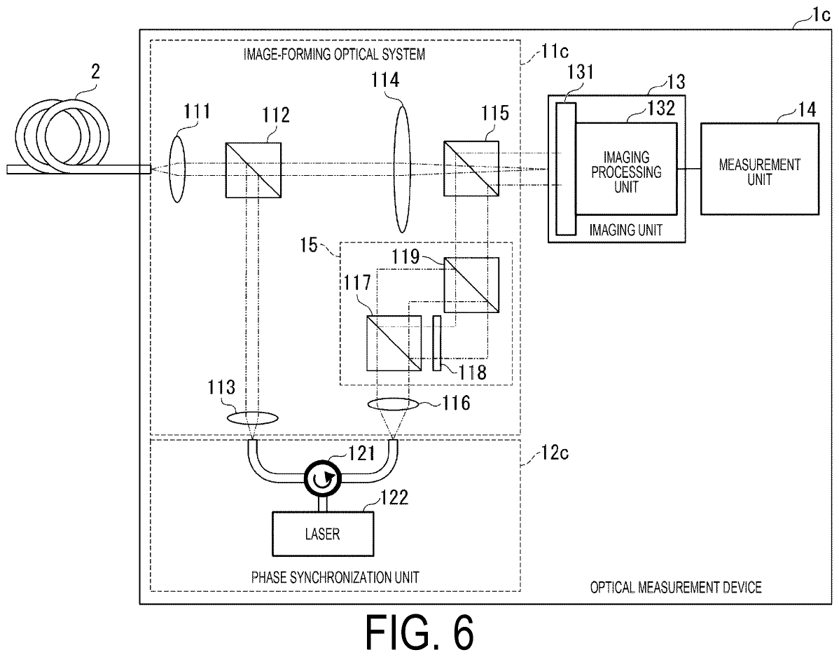

FIG. 6 is a diagram illustrating a configuration example of an optical measurement device lc according to the third embodiment. The optical measurement device 1c includes an image-forming optical system 11c, a phase synchronization unit 12c, an imaging unit 13, and a measurement unit 14.

The image-forming optical system 11c includes a lens 111, a beam splitter 112, a lens 113, a lens 114, a beam combiner 115, a lens 116, and a polarization multiplexing unit 15. The polarization multiplexing unit 15 includes a beam splitter 117, a λ/2 wavelength plate 118 (“λ” represents a wavelength), and a beam combiner 119. The phase synchronization unit 12a includes an optical circulator 121 and a laser 122. The imaging unit 13 includes an imaging surface 131 and an imaging processing unit 132.

In the third embodiment, the image-forming optical system 11c includes a polarization multiplexing unit for polarization-multiplexing the reference light so that the optical complex amplitude distribution of the object light is measured for each polarization component of the object light. The polarization-multiplexed reference light may be projected onto the imaging surface 131 at different angles for each polarization component.

In this case, since the band of the spatial frequency is recorded for each polarization component, the measurement unit 14 separates polarization components by signal processing on the image signal.

The beam splitter 117 demultiplexes the reference light emitted from the lens 116 to the λ/2 wavelength plate 118 and the beam combiner 119. The λ/2 wavelength plate 118 changes the polarization of one of the demultiplexed reference light beams in a direction orthogonal to the original polarization direction.

The polarization multiplexing unit 15 may include a first mirror (not illustrated) and a second mirror (not illustrated).

The first mirror (not illustrated) adjusts an angle of an optical path passing through the beam splitter 117. The second mirror (not illustrated) adjusts an angle of an optical path passing through the λ/2 wavelength plate 118.

The beam combiner 119 multiplexes the light emitted from the beam splitter 117 and the light emitted from the λ/2 wavelength plate 118. The beam combiner 119 emits the multiplexed emission light to the beam combiner 115 as polarization-multiplexed reference light.

As described above, in the image-forming optical system 11c, the polarization multiplexing unit 15 polarization-multiplexes the reference light. Thus, after the optical complex amplitude distribution of the object light is measured for each polarization component of the object light, it is possible to measure the optical complex amplitude distribution at the emission end of the multimode fiber having a predetermined length or more at low cost.

### Fourth Embodiment

A fourth embodiment is different from the first embodiment mainly in that the phase synchronization unit includes a “separation unit” and “N×1 coupler”. In the fourth embodiment, the difference from the first embodiment will be mainly described.

In a case where the phase synchronization unit includes a single mode fiber optical system and the image-forming optical system includes a free space optical system, since the image-forming optical system causes the object light to enter the phase synchronization unit, the image-forming optical system may use a lens or the like, and the image-forming optical system may cause the object light to enter the end face of the optical fiber of the phase synchronization unit.

However, only the light having the optical complex amplitude distribution matching the lowest-order mode of the optical fiber can be incident on (coupled to) the single mode fiber, and thus the object light beam in the higher-order mode among the object light beams incident on the single-mode fiber is lost. Therefore, since the amount the lowest-order mode light incident on the single mode fiber changes according to the change in optical complex amplitude distribution of the object light, injection synchronization becomes unstable.

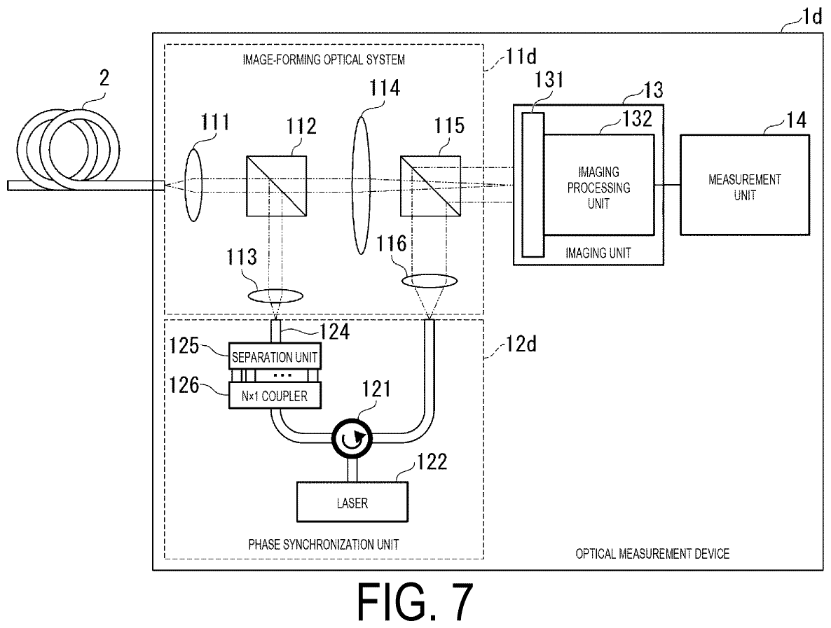

FIG. 7 is a diagram illustrating a configuration example of an optical measurement device 1d according to the fourth embodiment. The optical measurement device 1d includes an image-forming optical system 11d, a phase synchronization unit 12d, an imaging unit 13, and a measurement unit 14.

The image-forming optical system 11d includes a lens 111, a beam splitter 112, a lens 113, a lens 114, a beam combiner 115, and a lens 116. The phase synchronization unit 12d includes an optical circulator 121, a laser 122, a multimode fiber 124, a separation unit 125, and an N×1 coupler 126. The imaging unit 13 includes an imaging surface 131 and an imaging processing unit 132.

The multimode fiber 124 is a light reception multimode fiber having N modes. The end face of the multimode fiber can be coupled to light having a higher-order mode shape, unlike the end face of the single mode fiber. Therefore, even in a case where the optical complex amplitude distribution of the object light changes and the ratio between the lowest-order mode and the higher-order mode at the end face of the multimode fiber 124 changes, the multimode fiber 124 can be coupled to all the light beams in the modes from the lowest-order mode to the higher-order mode within the range of the mode of the multimode fiber 124.

The separation unit 125 (mode demultiplexer) separates the light beams coupled to the multimode fiber 124 for each mode. The N×1 coupler 126 multiplexes the separated object light beams for each mode. The N×1 coupler 126 causes the multiplexed object light to enter the single mode fiber of the optical circulator 121. By combining the separation unit 125 and the N×1 coupler 126 in this manner, the object light is incident on the optical circulator 121 (single mode system).

As described above, the separation unit 125 separates the light beams coupled to the multimode fiber 124 for each mode. The N×1 coupler 126 multiplexes the separated object light beams for each mode. Thus, after the injection synchronization is stably performed, it is possible to measure the optical complex amplitude distribution at the emission end of the multimode fiber having a predetermined length or more at low cost. It is possible to make the light intensity of the incident light on the optical circulator 121 close to a constant value regardless of the ratio of the light intensity of each mode. Furthermore, it is possible to reduce the influence of the variation in optical complex amplitude distribution of the object light.

### Fifth Embodiment

A fifth embodiment is different from the first embodiment mainly in that the phase synchronization unit synchronizes the frequency and phase of the reference light with the frequency and phase of the object light by using an optical phase-locked loop instead of injection synchronization. In the fifth embodiment, the difference from the first embodiment will be mainly described.

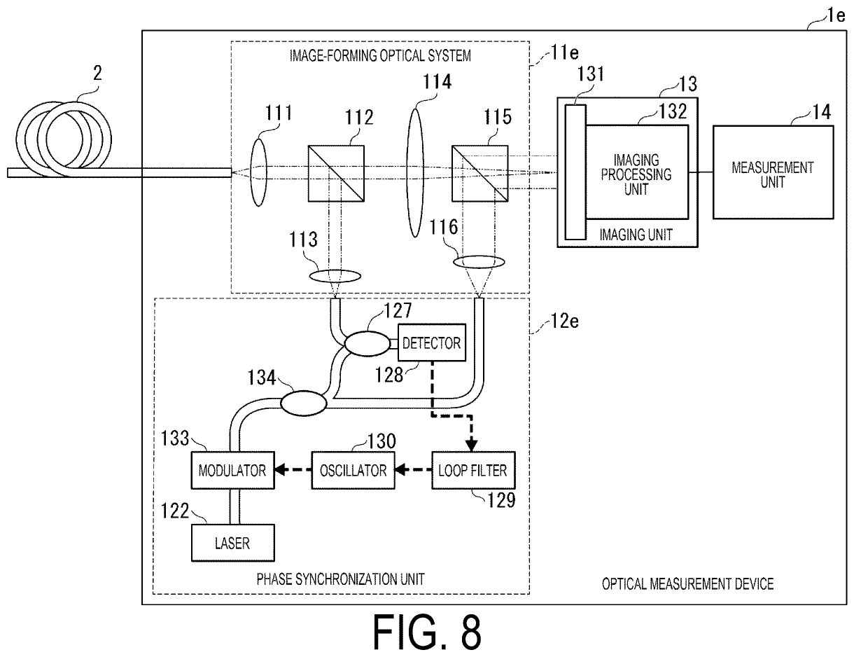

FIG. 8 is a diagram illustrating a configuration example of an optical measurement device 1e according to the fifth embodiment. The optical measurement device 1e includes an image-forming optical system 11e, a phase synchronization unit 12e, an imaging unit 13, and a measurement unit 14.

The image-forming optical system 11e includes a lens 111, a beam splitter 112, a lens 113, a lens 114, a beam combiner 115, and a lens 116. The phase synchronization unit 12e includes a laser 122, an optical coupler 127, a detector 128, a loop filter 129, an oscillator 130, a modulator 133, and an optical coupler 134. The imaging unit 13 includes an imaging surface 131 and an imaging processing unit 132.

The phase synchronization unit 12e uses, for example, an optical phase-locked loop (OPLL) to synchronize the frequency and phase of the laser beam (reference light) of the laser 122 with the frequency and phase of one incident light beam (object light) demultiplexed by the image-forming optical system 11e.

The laser 122 emits laser beam having a predetermined frequency and phase to the modulator 133. The optical coupler 127 multiplexes the light emitted from the optical coupler 134 and the light emitted from the multimode fiber on which the object light from the lens 113 is incident. The detector 128 (phase detector) detects the phase of a beat signal in the multiplexed emission light. The detector 128 outputs a phase signal (voltage signal) representing the phase of the beat signal to the loop filter 129.

The loop filter 129 performs filtering processing on the phase signal. The loop filter 129 outputs the phase signal (voltage signal) subjected to the filtering processing to the oscillator 130. The oscillator 130 (voltage-controlled oscillator) changes the frequency of the output signal of the oscillator 130 in proportion to the phase signal input to the oscillator 130. The oscillator 130 (voltage-controlled oscillator) feeds back the output signal to the modulator 133.

The modulator 133 (optical modulator) modulates the laser beam emitted from the laser 122 according to the output signal from the oscillator 130. Thus, the frequency and the phase of the laser beam are synchronized with the frequency and the phase of the object light. The optical coupler 134 emits the laser beam (laser signal) whose frequency and phase are synchronized to the lens 116.

As described above, the phase synchronization unit 12e uses the optical phase-locked loop to synchronize the second frequency and second phase of the reference light with the first frequency and first phase of the first demultiplexed light. Thus, it is possible to measure the optical complex amplitude distribution at the emission end of the multimode fiber having a predetermined length or more at low cost.

Although the embodiments of the present invention have been described above in detail with reference to the drawings, a specific configuration is not limited to the embodiments, and includes design and the like without departing from the spirit of the present invention.

### INDUSTRIAL APPLICABILITY

The present invention is applicable to a system that measures optical characteristics of the optical fiber.

### REFERENCE SIGNS LIST

1a, 1b, 1c, 1d, 1e Optical measurement device
11a, 11b, 11c, 11d, 11e Image-forming optical system
12a, 12b, 12c, 12d, 12e Phase synchronization unit
13 Imaging unit
14 Measurement unit
15 Polarization multiplexing unit
100 Intensity signal
101 Intensity signal
111 Lens
112 Beam splitter
113 Lens
114 Lens
115 Beam combiner
116 Lens
117 Beam splitter
118 λ/2 wavelength plate
119 Beam combiner
121 Optical circulator
122 Laser
123 Amplifier
124 Multimode fiber
125 Separation unit
126 N×1 coupler
127 Optical coupler
128 Detector
129 Loop filter
130 Oscillator
131 Imaging surface
132 Imaging processing unit
133 Modulator

1. An optical measurement device comprising: an image-forming optical system; a phase synchronizer;
an imager; and a measurement instrument,
wherein the image-forming optical system generates first demultiplexed light and second demultiplexed light by demultiplexing object light from an end face of an optical fiber, and projects the second demultiplexed light and reference light onto the imager,
the phase synchronizer emits, to the image-forming optical system, the reference light of a second frequency and a second phase which are synchronized with a first frequency and a first phase of the first demultiplexed light,
the imager images the projected second demultiplexed light and the projected reference light, and
the measurement instrument measures an optical complex amplitude distribution at the end face on a basis of the imaged second demultiplexed light and the imaged reference light.

22. The optical measurement device according to claim 1, wherein the phase synchronizer uses injection synchronization or an optical phase-locked loop to synchronize the second frequency and the second phase of the reference light with the first frequency and the first phase of the first demultiplexed light.

3. The optical measurement device according to claim 1, wherein the image-forming optical system emits the first demultiplexed light to the phase synchronizer.

4. An optical measurement method executed by an optical measurement device including an image-forming optical system, a phase synchronizer, an imager, and a measurement instrument, the optical measurement method comprising:
by the image-forming optical system, generating first demultiplexed light and second demultiplexed light by demultiplexing object light from an end face of an optical fiber, and projecting the second demultiplexed light and reference light onto the imager,
by the phase synchronizer, emitting, to the image-forming optical system, the reference light of a second frequency and a second phase which are synchronized with a first frequency and a first phase of the first demultiplexed light,
by the imager, imaging the projected second demultiplexed light and the projected reference light, and
by the measurement instrument, measuring an optical complex amplitude distribution at the end face on a basis of the imaged second demultiplexed light and the imaged reference light.

5. The optical measurement method according to claim 4, comprising, by the phase synchronizer, using injection synchronization or an optical phase-locked loop to synchronize the second frequency and the second phase of the reference light with the first frequency and the first phase of the first demultiplexed light.

6. The optical measurement method according to claim 4, comprising, by the image-forming optical system, emitting the first demultiplexed light to the phase synchronizer unit.
